(19) United States
(12) Patent Application Publication
(10) Pub. No.: US 2020/0319395 A1
(43) Pub. Date: Oct. 8, 2020

(54) BACKLIGHT STRUCTURE AND DISPLAY APPARATUS

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Yanming WANG, Beijing (CN); Cuie WANG, Beijing (CN); Chao YU, Beijing (CN); Cheng CHANG, Beijing (CN); Rui LIU, Beijing (CN); Dawei WANG, Beijing (CN); Gang LIU, Beijing (CN); Jingfei MU, Beijing (CN)

(21) Appl. No.: 16/303,746

(22) PCT Filed: Mar. 27, 2018
(86) PCT No.: PCT/CN2018/080638

§ 371 Date: Nov. 21, 2018

(30) Foreign Application Priority Data
Apr. 1, 2017 (CN) 201710215802.8

(51) Int. Cl. F21V 8/00

(52) U.S. Cl. CPC G02B 6/0076; G02B 6/0055; G02B 6/0085

(57) ABSTRACT

Disclosed are a backlight structure and a display apparatus. The backlight structure includes a sub-backlight unit and a side-type main backlight module. The main backlight module includes a main reflector plate. The main reflector plate is provided with at least one transmission region. The sub-backlight unit is provided at a side of the main backlight module where the main reflector plate is provided. A light exiting side of the sub-backlight unit is provided in correspondence with the transmission region such that light emitted from the sub-backlight unit transmits through the transmission region.

### CROSS-REFERENCE TO RELATED APPLICATION

This application claims priority to Chinese Patent Application No. 201710215802.8, filed on Apr. 1, 2017, the entire contents of which are hereby incorporated by reference.

### TECHNICAL FIELD

The present disclosure relates to the field of display technology, and particularly, to a backlight structure and a display apparatus.

### BACKGROUND

With the development of the smart phones, display devices with large screen size, high resolution and VR (Virtual Reality) compatibility become a main stream.

The display device is only required to perform a partial display in some application environments, e.g., checking basic information such as time, incoming calling, push notification, etc., single-hand operation mode, VR operation mode, or the like.

### SUMMARY

In an aspect, the present disclosure provides a backlight structure including a sub-backlight unit and a side-type main backlight module. The main backlight module includes a main reflector plate, and the main reflector plate is provided with at least one transmission region. The sub-backlight unit is provided at a side of the main backlight module where the main reflector plate is provided, and a light exiting side of the sub-backlight unit is provided in correspondence with the transmission region such that light emitted from the sub-backlight unit transmits through the transmission region.

In some embodiments, the main backlight module further includes a main light guide plate, a main backlight source is provided at a light receiving side of the main light guide plate, and the main reflector plate is provided at a side of the main light guide plate close to the sub-backlight unit.

In some embodiments, the sub-backlight unit includes a sub-light guide plate, a sub-backlight source is provided at a light receiving side of the sub-light guide plate, and a sub-reflector plate is provided at a side of the sub-light guide plate away from the main backlight module.

In some embodiments, a sub-light shielding adhesive is provided above the sub-backlight source, and the sub-light shielding adhesive has a thickness in a range of approximately 0.03 mm to approximately 0.3 mm.

In some embodiments, the sub-light shielding adhesive has a thickness of approximately 0.03 mm.

In some embodiments, the sub-light shielding adhesive has a thickness of approximately 0.05 mm.

In some embodiments, the sub-backlight unit further includes a sub-flexible printed circuit board, the sub-backlight source is provided on the sub-flexible printed circuit board, and the sub-flexible printed circuit board has a thickness in a range of approximately 0.06 mm to approximately 0.13 mm.

In some embodiments, the sub-flexible printed circuit board has a thickness of approximately 0.06 mm.

In some embodiments, a heat dissipation plate is provided at a side of the sub-flexible printed circuit board away from the sub-backlight source, and the heat dissipation plate is configured to fixedly connect the sub-flexible printed circuit board with the sub-reflector plate.

In some embodiments, the transmission region has a circular shape or a quadrilateral shape with round corners.

In some embodiments, the transmission region is an opening provided in the main reflector plate.

In some embodiments, an orthographic projection of a light exiting surface of the sub-backlight unit on a plane in parallel with the main reflector plate and an orthographic projection of the transmission region on the plane at least partially overlap with each other.

In some embodiments, an orthographic projection of a light exiting surface of the sub-backlight unit on a plane in parallel with the main reflector plate covers an orthographic projection of the transmission region on the plane.

In another aspect, the present disclosure further provides a display apparatus including a display panel and any one of the backlight structures described herein, and the display panel is provided at a light exiting side of the backlight structure.

In some embodiments, the display apparatus further includes a housing, and the housing is configured to accommodate the display panel and the backlight structure. The housing is provided at a bottom thereof a groove, and the sub-backlight unit is at least partially accommodated in the groove.

In some embodiments, the sub-backlight unit and the main backlight module are of an integral structure.

In some embodiments, the sub-backlight unit and the housing are of an integral structure.

### BRIEF DESCRIPTION OF THE DRAWINGS

FIG. 1 is a diagram illustrating a split structure of a display apparatus including a backlight structure in some embodiments according to the present disclosure:

FIG. 2 is a diagram illustrating an assembled structure of the display apparatus including the backlight structure illustrated in FIG. 1,

FIG. 3 is diagram illustrating a split structure of a display apparatus including a backlight structure in some embodiments according to the present disclosure;

FIG. 4 is a diagram illustrating an assembled structure of the display apparatus including the backlight structure illustrated in FIG. 3;

FIG. 5 is diagram illustrating a split structure of a display apparatus including a backlight structure in some embodiments according to the present disclosure; and

FIG. 6 is a diagram illustrating an assembled structure of the display apparatus including the backlight structure illustrated in FIG. 5.

### DETAILED DESCRIPTION

To make those skilled in the art better understand the technical solutions of the present disclosure, a backlight structure and a display apparatus according to the present disclosure will be described in detail below in conjunction with the accompanying drawings. The following embodiments described with reference to the drawings are exemplary embodiments to explain the present disclosure, rather than construing as limitations to the present disclosure. It should be noted that the backlight structure and the display apparatus will be described below by taking a smart phone as an example, however, it should be appreciated by those skilled in the art that the embodiments of the present disclosure may also be applied to display apparatuses other than the smart phone, such as a tablet computer, a notebook computer, a display, a television, a monitor, an electronic paper, and the like.

With the development of the smart phones, display devices with large screen size (e.g., 5.5 inches, 5.7 inches, or 6.0 inches), high resolution (FHD (Full High Definition), QHD (Quarter High Definition), or UHD (Ultra High Definition)) and VR (Virtual Reality) compatibility become a main stream.

Further, the display device is only required to perform a partial display in some application environments, e.g., checking basic information such as time, incoming calling, push notification, etc., single-hand operation mode, VR operation mode, or the like.

Further, the requirement on user experience gradually increases, and high brightness, high color gamut and high contrast ratio are required.

The developments of display technologies and the requirement on the user experience have brought significant increase in power consumption and heat dissipation. Accordingly, the developments of display technologies and the requirement on the user experience have brought higher requirements on the battery of the smart phone. In the related art, the standby-time of the mobile phone is prolonged by increasing battery capacity or using quick charge or the like, which however increases a weight of the mobile phone or lowers the lifetime of the battery.

Accordingly, the present disclosure provides, inter alia, a backlight structure and a display apparatus that substantially obviate one or more of the problems due to limitations and disadvantages of the related art.

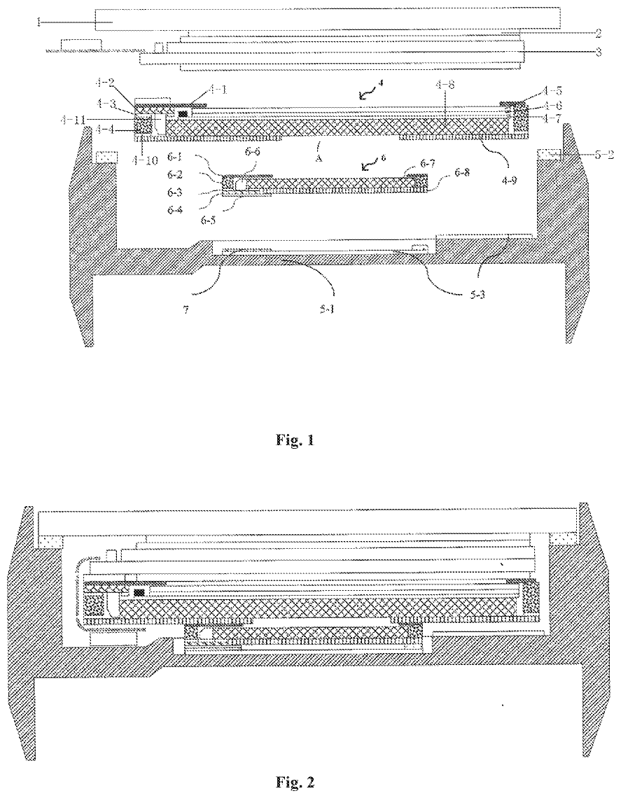

FIG. 1 is diagram illustrating a split structure of a display apparatus including a backlight structure in some embodiments according to the present disclosure; and FIG. 2 is a diagram illustrating an assembled structure of the display apparatus including the backlight structure illustrated in FIG. 1. As illustrated in FIGS. 1 and 2, the backlight structure in some embodiments includes a sub-backlight unit 6 and a side-type main backlight module 4.

The main backlight module 4 has a first side and a second side opposite to the first side, e.g., the first side is a light exiting side of the main backlight module 4. The sub-backlight module 6 has a third side and a fourth side opposite to the third side, e.g., the third side is a light exiting side of the sub-backlight unit 6.

The main backlight module 4 includes a main reflector plate 4-9, and at least one transmission region A is provided in the main reflector plate 4-9 (only one transmission region A is illustrated in the drawings by way of example). For example, the at least one transmission region A may be provided to be an opening in the main reflector plate 4-9. The shape and size and the like of the transmission region A may be set as desired. For example, the transmission region may have a circular shape or a quadrilateral shape with round corners.

The sub-backlight unit 6 is provided at a side of the main backlight module 4 where the main reflector plate 4-9 is provided. For example, as illustrated in FIGS. 1 and 2, the main reflector plate 4-9 is provided at the second side opposite to the light exiting side (the first side) of the main backlight module 4, and the sub-backlight unit 6 has the light exiting side (the third side) facing the second side.

Referring to FIGS. 1 and 2, the light exiting side of the sub-backlight unit 6 is provided correspondingly to the transmission region A such that the light emitted from the sub-backlight unit 6 transmits through the transmission region A. For example, in a case where the main reflector plate 4-9 is provided with an opening as the transmission region A, the light emitted from the sub-backlight unit 6 may directly transmit through the opening and enter the main backlight module 4. In some embodiments, an orthographic projection of a light exiting surface of the sub-backlight unit 6 on a plane in parallel with the main reflector plate 4-9 and an orthographic projection of the transmission region A on the plane at least partially overlap with each other. In some embodiments, the orthographic projection of the light exiting surface of the sub-backlight unit 6 on the plane in parallel with the main reflector plate 4-9 covers the orthographic projection of the transmission region A on the plane. In some embodiments, an orthographic projection of an effective light exiting surface of the sub-backlight unit 6 on the plane in parallel with the main reflector plate 4-9 and the orthographic projection of the transmission region A on the plane at least partially overlap with each other. In some embodiments, the orthographic projection of the effective light exiting surface of the sub-backlight unit 6 on the plane in parallel with the main reflector plate 4-9 covers the orthographic projection of the transmission region A on the plane. Here, the term “effective light exiting surface” refers to a surface from which light leaves the sub-backlight unit 6, e.g., a portion of the light exiting surface of the light guide plate of the sub-backlight unit 6 that is not covered by a light shielding adhesive.

It should be noted that a case where one sub-backlight unit is provided in correspondence with one transmission region is described in the embodiments of the present disclosure, but those skilled in the art should understand that, according to the embodiments of the present disclosure, one sub-backlight unit may be provided in correspondence with a plurality of transmission regions (e.g., a plurality of separated transmission regions), or a plurality of sub-backlight units may be provided in correspondence with one transmission region (e.g., one continuous transmission region).

Referring to FIGS. 1 and 2, in some embodiments, the main backlight module 4 further includes a main light guide plate 4-8, and a main backlight source 4-11, which is for example a light emitting diode, is provided at a light receiving side of the main light guide plate 4-8. The main reflector plate 4-9 is provided at a side of the main light guide plate 4-8 close to the sub-backlight unit 6. The sub-backlight unit 6 includes a sub-light guide plate 6-7, and a sub-backlight source 6-6, which is for example a light emitting diode, is provided at a light receiving side of the sub-light guide plate 6-7. A sub-reflector plate 6-8 is provided at a side of the sub-light guide plate 6-7 away from the main backlight module 4.

Referring to FIGS. 1 and 2, in some embodiments, a sub sub-light shielding adhesive 6-1 is provided above the sub-backlight source 6-6, and the sub-light shielding adhesive 6-1 has a thickness in a range of approximately 0.03 mm to approximately 0.3 mm. In some embodiments, the sub-light shielding adhesive has a thickness of approximately 0.03 mm or approximately 0.05 mm. In some embodiments, the sub-backlight unit 6 further includes a sub-flexible printed circuit board 6-4, the sub-backlight source 6-6 is provided on the sub-flexible printed circuit board 6-4, and the sub-flexible printed circuit board 6-4 has a thickness in a range of approximately 0.06 mm to approximately 0.13 mm. In some embodiments, the sub-flexible printed circuit board 6-4 has a thickness of approximately 0.06 mm. In some embodiments, a heat dissipation plate 6-5 is provided at a side of the sub-flexible printed circuit board 6-4 away from the sub-backlight source 6-6, and the heat dissipation plate 6-5 is adhesive and is configured to fixedly connect the sub-flexible printed circuit board 6-4 with the sub-reflector plate 6-8. In some embodiments, the heat dissipation plate 6-5 is made of graphite material to improve heat dissipation effect. In some embodiments, the sub-flexible printed circuit board 6-4 in provided thereon with a sub-light bar gum 6-3, and a sub-sealant 6-2 is provided on the sub-light bar gum 6-3.

Referring to FIGS. 1 and 2, in some embodiments, the main backlight module 4 further includes a main light shielding adhesive 4-1, a main flexible printed circuit board 4-2, a main light bar gum 4-3, a main sealant 4-4, a first prism 4-5, a second prism 4-6, a main diffuser film 4-7 and a main reflector plate gum 4-10. The main reflector plate gum 4-10 is provided at a side of the main reflector plate 4-9 away from the sub-backlight unit 6, the main sealant 4-4 is provided at a side of the main reflector plate gum 4-10 away from the main reflector plate 4-9, the main light bar gum 4-3 is provided at a side of the main sealant 4-4 away from the main reflector plate gum 4-10, and the main flexible printed circuit board 4-2 is provided at a side of the main light bar gum 4-3 away from the main sealant 4-4.

Referring to FIGS. 1 and 2, the display apparatus further includes a display panel, which is provided at a light exiting side of the backlight structure and includes a cover glass 1, an optical transparent adhesive 2 and a display module 3. In some embodiments, the display apparatus further includes a housing 5-1. The housing 5-1 may be a middle frame of the display apparatus, which is configured to accommodate the display panel and the backlight structure. In some embodiments and referring to FIGS. 1 and 2, a bottom of the housing 5-1 is provided with a groove, and the sub-backlight unit 6 is at least partially accommodated in the groove. For example, the sub-backlight unit 6 is at least partially accommodated in the groove in a height direction of the sub-backlight unit 6. In some embodiments, a lower surface of the sub-backlight unit 6 and a bottom of the groove of the housing 5-1 have a safe distance therebetween ranging from approximately 0.2 mm to approximately 0.3 mm. In some embodiments, a side surface of the sub-backlight unit 6 and a side wall of the groove of the housing 5-1 have a safe distance therebetween ranging from approximately 0.2 mm to approximately 0.3 mm.

As illustrated in FIGS. 1 and 2, in some embodiments, a foam adhesive or a hot melt adhesive 5-2 may be provided between the cover glass 1 and the housing 5-1, and a buffer foam or graphite 5-3 may be provided at the bottom (including the bottom of the groove) of the housing 5-1, and a supporting buffer foam 7 may be provided on the buffer foam or graphite 5-3.

In actual applications, depending on different operating environments, the main backlight module and the sub-backlight unit may be freely switched (that is, one of the main backlight module and the sub-backlight unit is turned on and the other is turned off), or both of the main backlight module and the sub-backlight unit may be turned on at the same time. For example, when a partial display (e.g., displaying time, incoming call, push notification or the like) is performed, only the sub-backlight unit may be turned on while the main backlight module may be turned off, so that the power consumption of the display apparatus can be effectively lowered and the life time of the display apparatus can be prolonged. For another example, the main backlight module and the sub-backlight unit may be turned on concurrently to achieve requirements of high color gamut, high brightness and high contrast ratio.

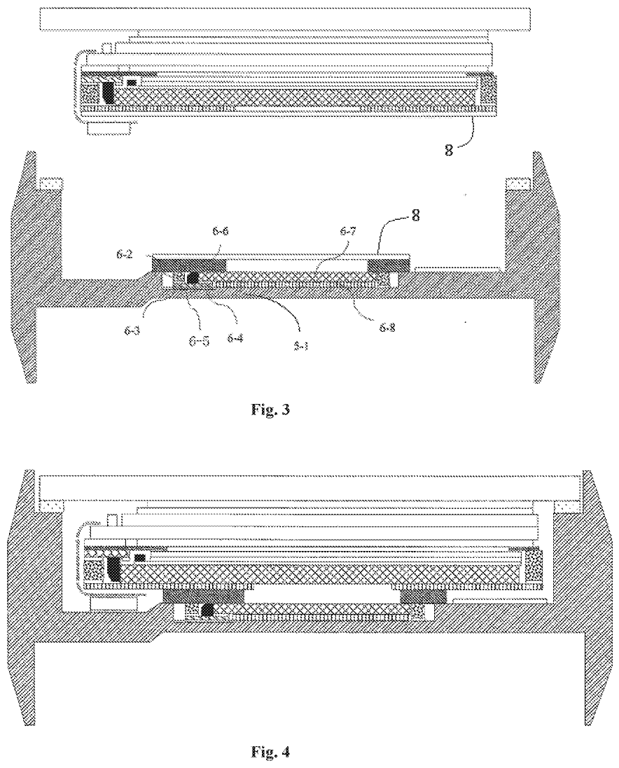

FIG. 3 is diagram illustrating a split structure of a display apparatus including a backlight structure in some embodiments according to the present disclosure; and FIG. 4 is a diagram illustrating an assembled structure of the display apparatus including the backlight structure illustrated in FIG. 3. A display panel, a main backlight module and a sub-backlight unit illustrated in FIGS. 3 and 4 have the same structures as those illustrated in FIGS. 1 and 2, details of which may refer to the description with respect to FIGS. 1 and 2, and will not be repeated here. The display apparatus illustrated in FIGS. 3 and 4 is different from the display apparatus illustrated in FIGS. 1 and 2 in that, the sub-backlight unit and the main backlight module illustrated in FIGS. 1 and 2 are of an integral structure and the sub-backlight unit and the housing illustrated in FIGS. 3 and 4 are of an integral structure.

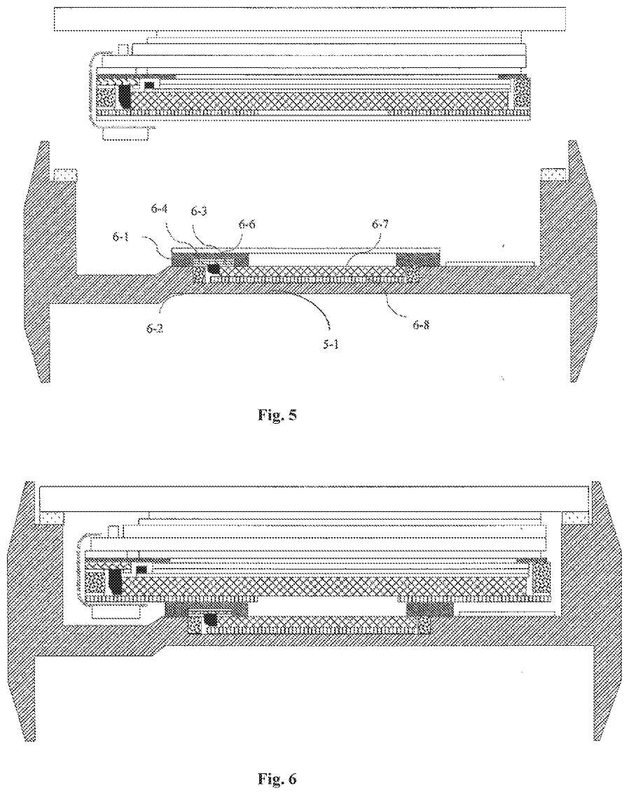

FIG. 5 is diagram illustrating a split structure of a display apparatus including a backlight structure in some embodiments according to the present disclosure; and FIG. 6 is a diagram illustrating an assembled structure of the display apparatus including the backlight structure illustrated in FIG. 5. A display panel and a main backlight module illustrated in FIGS. 5 and 6 have the same structures as those illustrated in FIGS. 1 and 2, details of which may refer to the description with respect to FIGS. 1 and 2, and will not be repeated here.

Similar to the display apparatus illustrated in FIGS. 3 and 4, in the display apparatus illustrated in FIGS. 5 and 6, the sub-backlight unit and the housing are of an integral structure. The display apparatus illustrated in FIGS. 5 and 6 is different from the display apparatus illustrated in FIGS. 3 and 4 in that, the sub-sealant 6-2, the sub-light bar gum 6-3 and the sub-flexible printed circuit board 6-4 are assembled with the housing 5-1 as illustrated in FIGS. 3 and 4 and the sub-sealant 6-2 and the housing 5-1 are integrally formed by pouring as illustrated in FIGS. 5 and 6.

More specifically, referring to FIGS. 5 and 6, the sub-reflector plate 6-8 and the sub-sealant 6-2 are provided at the bottom of the groove of the housing 5-1, the sub-light guide plate 6-7 is provided on the sub-reflector plate 6-8, the sub-backlight source (light emitting diode) 6-6 is provided on a lower surface of the sub-flexible printed circuit board 6-4 in a upside down manner, the sub-light bar gum 6-3 is provided on an upper surface of the sub-flexible printed circuit board 6-4, and the sub-light shielding adhesive 6-1 is provided on the sub-light bar gum 6-3.

Additionally, in each of the display apparatuses illustrated in FIGS. 3 to 6, a protection film 8 is further included, which is removed when assembling the display apparatus.

According to the embodiments of the present disclosure, the backlight structure includes a sub-backlight unit and a main backlight module which is side-type, the main backlight module includes a main reflector plate, the main reflector plate is provided with at least one transmission region, the sub-backlight unit is provided at a side of the main backlight module where the main reflector plate is provided, and a light exiting side of the sub-backlight unit is provided in correspondence with the transmission region such that light emitted from the sub-backlight unit transmits through the transmission region. In actual applications, depending on different operating environments, the main backlight module and the sub-backlight unit may be freely switched (that is, one of the main backlight module and the sub-backlight unit is turned on and the other is turned off) to effectively lower the power consumption of the display apparatus and prolonging the life time of the display apparatus, or both of the main backlight module and the sub-backlight unit may be turned on concurrently to meet requirements of high color gamut, high brightness and high contrast ratio. According to the embodiments of the present disclosure, in the display apparatus, the sub-backlight unit is provided in the groove of the housing, and the main backlight module and the sub-backlight unit can share a same display panel, thereby avoiding the need to provide a separate secondary display screen in addition to the main display screen while producing a small influence on the structural strength, thickness and quality of the display apparatus.

It can be understood that the foregoing embodiments are merely exemplary embodiments used for describing the principle of the present disclosure, but the present disclosure is not limited thereto. Those of ordinary skill in the art may make various variations and improvements without departing from the spirit and essence of the present invention, and these variations and improvements shall also fall into the protection scope of the present disclosure.

1. A backlight structure, comprising a sub-backlight unit and a side-type main backlight module, wherein the main backlight module comprises a main reflector plate, the main reflector plate is provided with at least one transmission region, the sub-backlight unit is provided at a side of the main backlight module where the main reflector plate is provided, and a light exiting side of the sub-backlight unit is provided in correspondence with the transmission region such that light emitted from the sub-backlight unit transmits through the transmission region.

2. The backlight structure of claim 1, wherein the main backlight module further comprises a main light guide plate, a main backlight source is provided at a light receiving side of the main light guide plate, and the main reflector plate is provided at a side of the main light guide plate close to the sub-backlight unit.

3. The backlight structure of claim 1, wherein the sub-backlight unit comprises a sub-light guide plate, a sub-backlight source is provided at a light receiving side of the sub-light guide plate, and a sub-reflector plate is provided at a side of the sub-light guide plate away from the main backlight module.

4. The backlight structure of claim 3, wherein a sub-light shielding adhesive is provided above the sub-backlight source, and the sub-light shielding adhesive has a thickness in a range of approximately 0.03 mm to approximately 0.3 mm.

5. The backlight structure of claim 4, wherein the sub-light shielding adhesive has a thickness of approximately 0.03 mm.

6. The backlight structure of claim 4, wherein the sub-light shielding adhesive has a thickness of approximately 0.05 mm.

7. The backlight structure of claim 3, wherein the sub-backlight unit further comprises a sub-flexible printed circuit board, the sub-backlight source is provided on the sub-flexible printed circuit board, and the sub-flexible printed circuit board has a thickness in a range of approximately 0.06 mm to approximately 0.13 mm.

8. The backlight structure of claim 7, wherein the sub-flexible printed circuit board has a thickness of approximately 0.06 mm.

9. The backlight structure of claim 7, wherein a heat dissipation plate is provided at a side of the sub-flexible printed circuit board away from the sub-backlight source, and the heat dissipation plate is configured to fixedly connect the sub-flexible printed circuit board with the sub-reflector plate.

10. The backlight structure of claim 1, wherein the transmission region has a circular shape or has a quadrilateral shape with round corners.

11. The backlight structure of claim 1, wherein the transmission region is an opening provided in the main reflector plate.

12. The backlight structure of claim 1, wherein an orthographic projection of a light exiting surface of the sub-backlight unit on a plane in parallel with the main reflector plate and an orthographic projection of the transmission region on the plane at least partially overlap with each other.

13. The backlight structure of claim 1, wherein an orthographic projection of a light exiting surface of the sub-backlight unit on a plane in parallel with the main reflector plate covers an orthographic projection of the transmission region on the plane.

14. A display apparatus, comprising a display panel and a backlight structure, the display panel being provided at a light exiting side of the backlight structure,
wherein backlight structure comprises a sub-backlight unit and a side-type main backlight module,
wherein the main backlight module comprises a main reflector plate, the main reflector plate is provided with at least one transmission region, the sub-backlight unit is provided at a side of the main backlight module where the main reflector plate is provided, and a light exiting side of the sub-backlight unit is provided in correspondence with the transmission region such that light emitted from the sub-backlight unit transmits through the transmission region.

15. The display apparatus of claim 14, further comprising a housing, wherein the housing is configured to accommodate the display panel and the backlight structure, a groove is provided at a bottom of the housing, and the sub-backlight unit is at least partially accommodated in the groove.

16. The display apparatus of claim 15, wherein the sub-backlight unit and the main backlight module are of an integral structure.

17. The display apparatus of claim 15, wherein the sub-backlight unit and the housing are of an integral structure.

18. The display apparatus of claim 14, wherein the main backlight module further comprises a main light guide plate, a main backlight source is provided at a light receiving side of the main light guide plate, and the main reflector plate is provided at a side of the main light guide plate close to the sub-backlight unit.

19. The display apparatus of claim 14, wherein the sub-backlight unit comprises a sub-light guide plate, a sub-backlight source is provided at a light receiving side of the sub-light guide plate, and a sub-reflector plate is provided at a side of the sub-light guide plate away from the main backlight module.

20. The display apparatus of claim 14, wherein an orthographic projection of a light exiting surface of the sub-backlight unit on a plane in parallel with the main reflector plate and an orthographic projection of the transmission region on the plane at least partially overlap with each other.
